(19) United States
(12) Patent Application Publication
(10) Pub. No.: US 2002/0147641 A1
(43) Pub. Date: Oct. 10, 2002

(54) Method and apparatus for rewarding behavior beneficial to health

(76) Inventors: Michele Hickford, San Jose, CA (US); Andreas Bibl, Los Altos, CA (US); Deane Gardner, Cupertino, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/827,230

(22) Filed: Apr. 4, 2001

(51) Int. Cl. G06F 17/60

(52) U.S. Cl. 705/14

(57) ABSTRACT

A method and system for rewarding behavior beneficial to health are described. In one embodiment, the method includes enrollin

### BACKGROUND OF THE INVENTION

1. Field of the Invention

The present invention relates to computerized reward systems. More particularly, the present invention relates to rewarding behavior beneficial to health.

2. Background Information

Methods and systems for rewarding usage of credit card accounts are well known. Such methods and systems are generally designed to reward a credit card holder for exhibiting behavior preferred by a credit card issuer. For instance, the issuer of the Discover card offers an annual cash rebate based upon a card holder's annual charge volume. Another example of a conventional reward program is a frequent flyer mile reward program which allows their participants to earn points towards free airline tickets if the participants travel with a particular airline, use a designated credit card for their purchases, or use a particular long distance telephone company. Conventional reward programs also include online reward programs that encourage surfing of the Internet, online shopping, or use of email systems.

A common feature of the above reward programs is that they promote consumer behavior of their participants, rather than behavior beneficial to their health, such as fitness activity, dietary habits, self-care medical treatment, etc. However, rewarding behavior beneficial to health would help participants of such a reward program to maintain good health, increase work productivity and reduce medical expenses, thereby benefiting not only the participants themselves but also third parties (e.g., parents, employers, healthcare providers, etc.) and the society in general.

### SUMMARY OF THE INVENTION

A method and system for rewarding behavior beneficial to health are described. In one embodiment, the method includes enrolling a user into a reward program that encourages user behavior beneficial to health, collecting data associated with the user behavior beneficial to health, and evaluating the collected data to determine whether the collected data satisfies a performance target defined by the reward program.

### BRIEF DESCRIPTION OF THE DRAWINGS

The present invention is illustrated by way of example and may be better understood by referring to the following description in conjunction with the accompanying drawings, in which like references indicate similar elements and in which:

FIG. 1 is a block diagram of one embodiment for a network architecture;

FIG. 2 is a block diagram of one embodiment for an architecture of a computer system;

FIG. 3 is a flow diagram of a method for rewarding behavior beneficial to health, according to one embodiment of the present invention;

FIG. 4 is a block diagram of one embodiment for a personal data capture device; and

FIG. 5 is a flow diagram of a method for monitoring user behavior beneficial to health, according to one embodiment of the present invention.

### DETAILED DESCRIPTION OF AN EMBODIMENT OF THE PRESENT INVENTION

A method and system for rewarding behavior beneficial to health are described. In the following detailed description of the present invention, numerous specific details are set forth in order to provide a thorough understanding of the present invention. However, it will be apparent to one skilled in the art that the present invention may be practiced without these specific details. In some instances, well-known structures and devices are shown in block diagram form, rather than in detail, in order to avoid obscuring the present invention.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of processing blocks leading to a desired result. The processing blocks are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

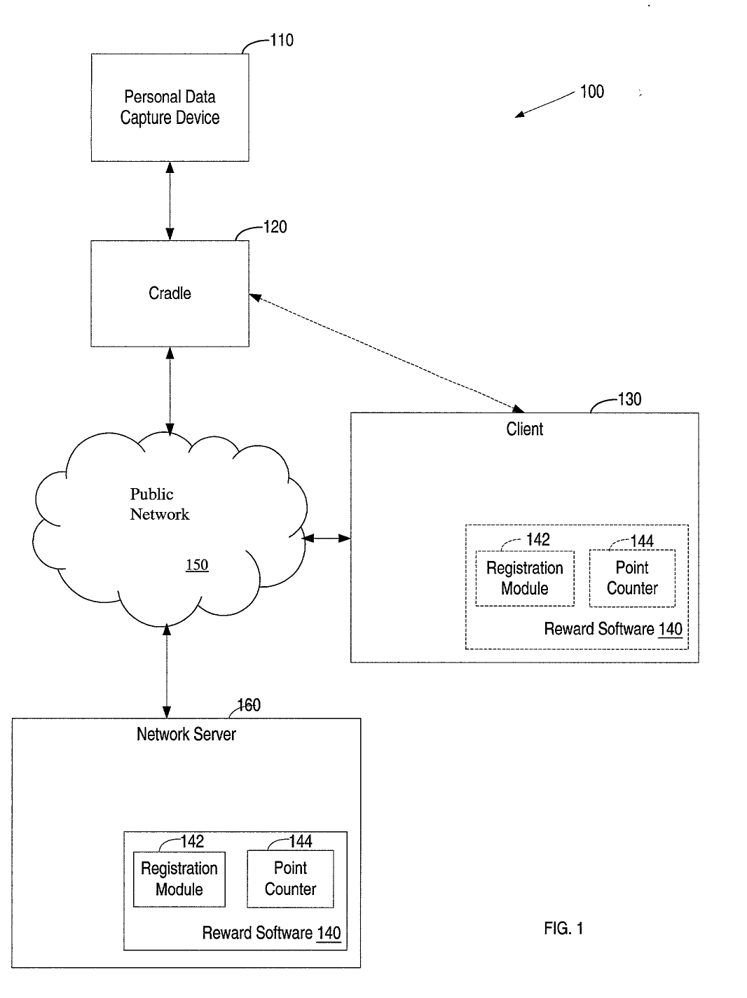

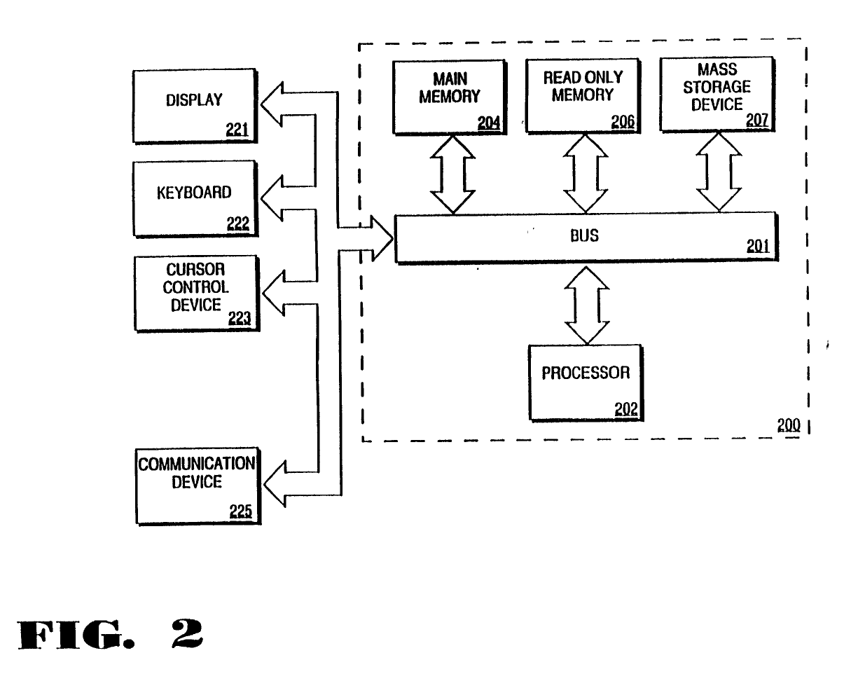

Referring now to FIG. 1, a block diagram of one embodiment for a network architecture is illustrated. In this embodiment, a personal data capture device 110 is coupled to cradle 120. Personal data capture device 110 may be used to monitor and store physical and biometrical parameters of its user. In this embodiment, personal data capture device 110 is an independent portable device. However, it will be recognized by one of ordinary skill in the art that a stationary device or a device included in some other device or equipment may be used with this invention without loss of generality. Personal data capture device 110 may be used by any person. For example, personal data capture device 110 may be used by a person engaged in fitness activity, a professional athlete during exercise, an employee wishing to know how his stress level changes during the day, a person engaged in self-care medical treatment, etc. The operation of personal data capture device 110 and its functions will be described in more detail below.

In one embodiment, cradle 120 is used to upload data from personal data capture device 110 to network 150. In an alternative embodiment, cradle 120 is used to upload data from personal data capture device 110 directly to client computer 130.

In one embodiment, cradle 120 may resemble a support element for a telephone receiver or handset. Cradle 120 may include a modem to transmit data over telephone lines and may be configured to provide two-way connection to wide area network 150. In one embodiment, placing personal data capture device 110 in cradle 120 may trigger an automatic dialing of a telephone number of server 160. When the telephone line is free, data from personal data capture device 110 may then be transmitted to server 160 through wide area network 150.

Alternatively, the data may be transmitted from personal data capture device to server 160 using a wireless transmitter. That is, cradle 120 is not used, and the data is transmitted over a wireless carrier. It should be understood by one of ordinary skill in the art that various ways of transmitting data from personal data capture device 110 to server 160 or client 130, other than those described above, may be used with this invention without loss of generality.

In one embodiment, server 160 is coupled to wide area network 150. Wide area network 150 may include, for example, the Internet, America On-Line™, CompuServe™, Microsoft Network™, or Prodigy™. In addition, wide area network 150 may include, for example, conventional network backbones, long-haul telephone lines, Internet service providers, or various levels of network routers. Using conventional network protocols, server 160 may communicate through wide area network 150 to a plurality of clients 130. Alternatively, server 160 may be coupled to client 130 over a private network such as, for example, a local area network (LAN), Intranet, Ethernet, etc. Client 130 may include, for example, a conventional computer system, a network computer or thin client device (e.g., WebTV Networks™ Internet terminal or Oracle™ NC), a laptop or palm-top computing device (e.g., Palm Pilot™), a digital consumer device (e.g., a digital TV, a digital camcorder, or a “kitchen” computer”), etc.

In one embodiment, server 160 includes reward software 140 which is used to offer the users a reward program to promote behavior beneficial to health. In another embodiment, reward software 140 resides on client computer 130, thereby enabling user participation in a reward program locally, without accessing server 160.

In one embodiment, reward software 140 includes a registration module 142 and a point counter 144. Registration module 142 is responsible for enrolling a user into a reward program that encourages user behavior beneficial to health. This behavior may include various fitness activities (e.g., walking, jogging, weight lifting, etc.) or dietary habits. Another example of such behavior may be a participation in a self-care medical treatment. For instance, people with chronic diseases such as asthma, diabetes, hypertension, etc., may be prescribed to regularly monitor their physiological conditions (e.g., blood pressure or blood glucose concentration) In this example, a reward program is intended to encourage its participants to comply with the prescribed preventative measures.

A reward program defines a performance target and other conditions that must be satisfied for winning an award. The performance target may be a certain number of steps that the user must take during a predefined period of time, a distance that the user must run in a day, a maximum number of calories consumed by the user, etc.

Point counter 144 is responsible for collecting personal data associated with the user behavior beneficial to health and evaluating this data to determine whether the user met the performance target. If the collected data satisfies the performance target, point counter 144 initiates a redeem process. In one embodiment, the collected data is data that is downloaded from personal data capture device 110 to client 130 periodically during the user's participation in the reward program. Alternatively, this data is periodically downloaded from personal data capture device 110 to server 160.

In one embodiment, the user is presented with constant feedback of behavior information and with a final result indicating whether the user has won an award. In one embodiment, the feedback and the final result are displayed on the user's personal web page on client computer 130.

Having briefly described one embodiment of the network environment in which the present invention operates, FIG. 2 illustrates an example of a computer system 200 illustrating an exemplary client 130 or server 160 computer system in which the features of the present invention may be implemented. Referring to FIG. 2, computer system 200 is comprised of a bus or other communications means 201 for communicating information, and a processing means such as processor 202 coupled with bus 201 for processing information. Computer system 200 further comprises a random access memory (RAM) or other dynamic storage device 204 (commonly referred to as main memory), coupled to bus 201 for storing information and instructions to be executed by processor 202. Main memory 204 also may be used for storing temporary variables or other intermediate information during execution of instructions by processor 202. Computer system 200 also comprises a read only memory (ROM) and/or other static storage device 206 coupled to bus 201 for storing static information and instructions for processor 202.

An optional data storage device 207 such as a magnetic disk or optical disk and its corresponding drive may also be coupled to computer system 200 for storing information and instructions. Computer system 200 can also be coupled via bus 201 to a display device 221, such as a cathode ray tube (CRT) or a liquid crystal display (LCD), for displaying information to a computer user. For example, graphical or textual information may be presented to the user on display device 221. Typically, an alphanumeric input device 222, including alphanumeric and other key is coupled to bus 201 for communicating information and/or command selections to processor 202. Another type of user input device is cursor control device 223, such as a conventional mouse, touch mouse, trackball, or other type of cursor direction keys for communicating direction information and command selection to processor 202 and for controlling cursor movement on display 221. A fully-loaded computer may optionally include video, camera, speakers, sound card, and many other conventional options.

Alternatively, client 130 can be implemented as any device described above. Such a device does not necessarily include all of the elements and features of the above-described exemplary computer system; however, the functionality of the present invention may nevertheless be implemented with such devices.

A communication device 225 is also coupled to bus 201 for accessing remote computers or servers, such as web server 160, or other servers via the Internet, for example. The communication device 225 may include a modem, a network interface card, or other well known interface devices, such as those used for interfacing with Ethernet, Token-ring, or other types of networks. In any event, in this manner, the computer system 200 may be coupled to a number of servers 160 via a network infrastructure such as the infrastructure illustrated in FIG. 1 and described above.

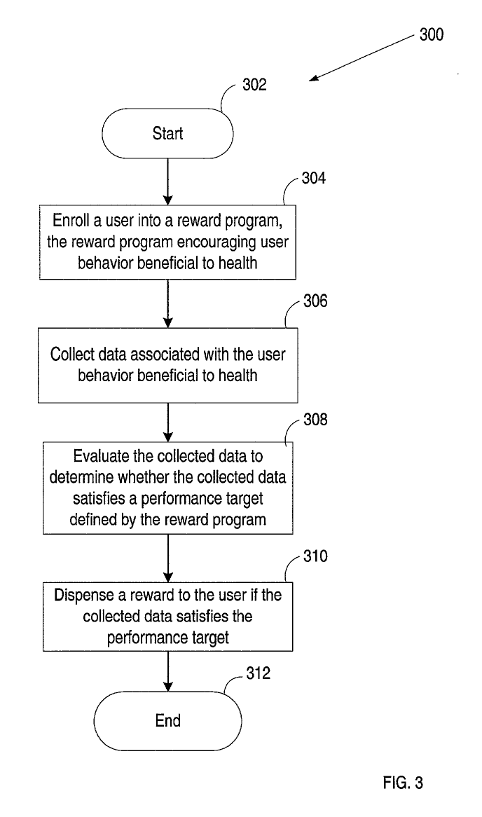

FIG. 3 is a flow diagram of a method 300 for rewarding behavior beneficial to health, according to one embodiment of the present invention. Method 300 begins with enrolling a user into a reward program that encourages user behavior beneficial to health (processing block 304). In one embodiment, the user is presented with a list of available reward programs and a list of available awards (e.g., a monetary award, a product, a coupon, a gift certificate, a free trip, etc.). Each reward program focuses on a particular health-related activity (e.g., walking, jogging, weight lifting, dieting, taking prescribed preventative measures, etc.) and defines a performance target for this activity. The user may select a preferred reward program and a desired award. Reward programs may be offered by an online service or various merchants. In addition, reward programs may be offered by third parties. A third party may be a parent or an employer. For instance, an employer may offer this reward program to its employees to encourage their health related activities, thereby aiming to increase their work productivity, reduce the number of the employees' sick days, and improve work environment. Similarly, a healthcare provider may offer its participants a reward program encouraging preventative medical treatment or dieting, etc. In one embodiment, a list of awards is determined for each available reward program using demographic reports. For example, prizes offered to potential participants located in New York may include tickets to Broadway shows while prizes offered to potential participants located in Indiana may include basketball game tickets.

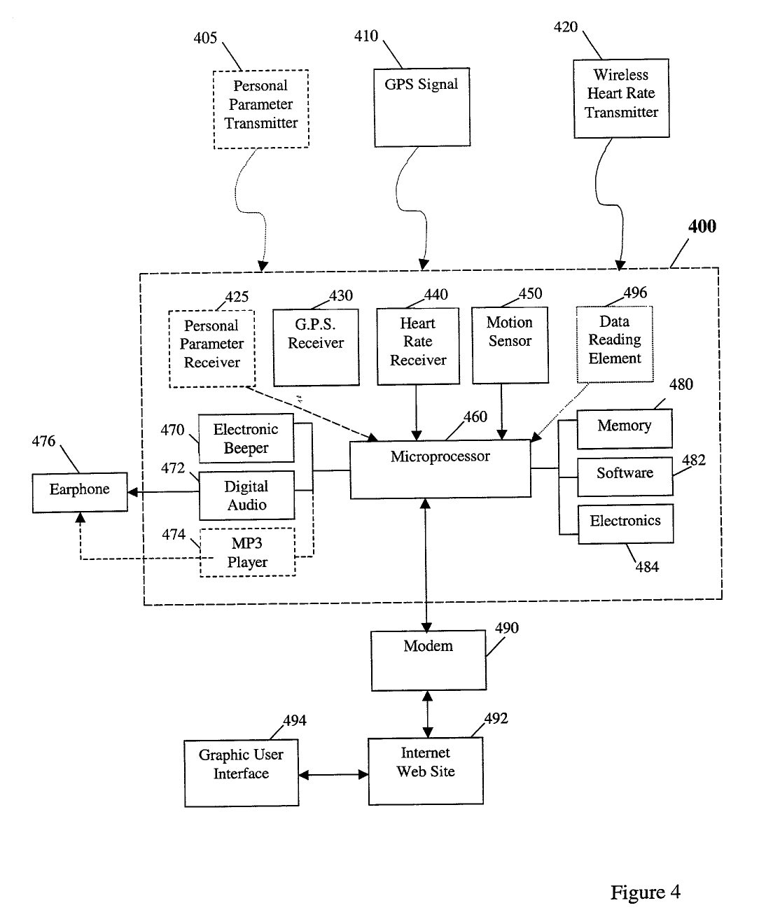

At processing block 306, data associated with the user behavior beneficial to health is collected. In one embodiment, the reward program defines a start date and an end date for the user's engagement in the behavior beneficial to health, and the user's personal data is collected during this period of time. In one embodiment, the data is collected automatically (i.e., the user is not required to provide any input) using a personal data capture device which will be described in greater detail below in conjunction with FIG. 4.

At processing block 308, the collected data is evaluated to determine whether it satisfies a performance target defined by the reward program. If the performance target is satisfied, a redeem process is initiated and an award is dispensed to the user (processing block 310). Alternatively, the user is informed that the user did not win an award.

Accordingly, a reward system is provided which encourages user behavior beneficial to health, automatically tracks the user behavior, and induces the user to strongly prove his or her interest (by persisting in behavior beneficial to health) in acquiring a product offered as a reward. In addition, such reward programs not only benefit the users but also third parties (e.g., parents, employers, schools, medical institutions, healthcare providers, etc.) who can employ these programs to influence health-related activities of groups of people.

The personal data capture device will now be described in more detail. FIG. 4 is a block diagram of one embodiment for a personal data capture device. Referring to FIG. 4, personal data capture device 400 includes microprocessor 460 which is coupled to memory 480, software program 482 and electronics 484. In one embodiment, personal data capture device 400 is a portable device. In this embodiment, personal data capture device 400 may be clipped to the user's waist band, or may be secured to the user in other ways such as via a wrist watch-type arrangement or by simply being held by the user. In alternate embodiments, personal data capture device 400 may be a stationary device or a device included in some other device or equipment.

In one embodiment, personal data capture device 400 includes a global positioning system (GPS) signal receiver 430 which receives GPS signals 410. GPS signals 410 may include three-dimensional positional information and velocity of the user when the user is walking or running, or is engaged in some other relevant activity. Personal data capture device 400 may also include a motion sensor 450 which may improve the accuracy of the above information or substitute it when GPS signal 410 is interrupted. In addition, personal data capture device 400 may include heart rate receiver 430 which receives heart beat rate from wireless heart rate transmitter 420. Various other sources may provide signals to personal data capture device 400. Personal parameter transmitter 405 represents a wide variety of signals that may be received by various personal parameter receivers 425 included in personal data capture device 400. For example, a bathroom weight scale may have a transmitter built in it to automatically transmit signals with weight data to personal data capture device 400. A blood pressure meter, a glucose meter, exercise equipment such as treadmills and stationary bikes, or any other device or equipment can transmit data to personal data capturing device 400 which will receive it using a corresponding personal parameter receiver 425. In one embodiment, heart rate receiver 440 is personal parameter receiver 425. It will be understood by one of ordinary skill in the art that all of the receivers described above or any combination of them may be included in personal data capture device 400 without loss of generality.

Upon receiving a signal, any of the receivers 425 through 450 outputs data to microprocessor 460. Microprocessor 460 stores this data in memory 480. In one embodiment, microprocessor 460 also receives data from a data reading element 496 which is used for obtaining a variety of health and fitness information of the user.

In one embodiment, data reading element 496 is a bar code scanner. In this embodiment, when the user scans barcodes related to a certain health, diet, or fitness activity, data reading element 496 reads the barcodes and passes them to microprocessor 460 which then stores them in memory 480. The barcodes may be related to any heath, diet, or fitness equipment in a gym or home, or any health, diet, or fitness activity (e.g. free weight lifting, jogging, running, swimming, monitoring food calories, etc). Barcodes related to a certain activity may include a code identifying equipment or activity and codes for a set of parameters associated with this equipment or activity. For example, barcodes for free weight lifting may include a code identifying free weight lifting, and codes identifying how much weight was lifted and a number of repetitions. Likewise, barcodes for a stationary bicycle may include a code identifying a bicycle and codes identifying the chosen program, its level of complexity, and the amount of time spent on this program. In another example, barcodes for monitoring food calories may include a code identifying a food product or a meal, and a code indicating the amount consumed. In this example, the code identifying the food product may be read from the package of the food product or from a recipe book which was used in preparing the meal. It will be understood by one of ordinary skill in the art that barcodes for a wide variety of health and fitness equipment and activities other than those described above can be used with data reading element 496 without loss of generality.

In one embodiment, server 160 contains a database which includes information on a variety of health, diet, and fitness equipment and activities This information includes identifiers of each equipment, food item, or activity and a set of parameters required for each equipment or activity. The information may be updated to add or modify equipment or activity and/or associated parameters. Based on the information in the database, server 160 may create barcodes for the requested equipment or activity. These barcodes may then be posted on a web site and printed by the user, or may be distributed in other ways (e.g. by mail, during a meeting with gym personnel, etc.).

In alternative embodiments, data reading element 154 may be a magnetic stripe reader, an optical reader, a charge coupled device (CCD) video capturing element, or an audible data capturing element.

In one embodiment, personal data capture device may include electronic beeper 470 for providing audio signals related to the personal data. For example, when personal data capture device 400 is configured over the network as described above, electronic beeper 470 can be set to signal low and high heart rate target limits, low and high pace limits, low and high weight limits, etc. Alternatively, or in addition to electronic beeper 470, personal data capture device 400 may include digital audio 472 to provide more detailed feedback. Digital audio 472 may be configured to provide various real time information (e.g., distance average speed) related to personal parameters transmitted to personal data capture device 400. Personal data capture device 400 may also include digital audio player such as MP3 player 474 to play digital recordings In one embodiment, the real time information generated by digital audio 472 and/or digital recordings played by MP3 player may be communicated to the user by earphone 476 coupled to digital audio 472 and/or MP3 player 474. It will be understood by one of ordinary skill in the art that any combination of personal data receivers 425 through 450 and audio signal generators 470 through 476 may be used with personal data capture device 400 without loss of generality.

In one embodiment, microprocessor 460 is coupled to modem 490 which is contained in a cradle. Modem 490 provides a direct two-way connection to server 160 and user's web site 492 over a wide area network. In this embodiment, when personal data capture device 400 is placed in the cradle, modem 490 automatically dials a phone number of server 160. When the phone line is free, software 482 causes microprocessor 460 to upload the user's personal data from memory 480 to server 160.

In another embodiment, personal data capture device 400 may transmit personal data directly to a client computer, and reward software uses this data to monitor the user's behavior beneficial to health.

In one embodiment, personal data capture device 400 may include a wireless transmitter (not shown) which may be used by microprocessor 460 to transmit the user's personal data from memory 480 to server 160 or a client computer via a wireless carrier.

In one embodiment, the user's personal data including data associated with the reward program may be posted on the user's web site 492. Alternatively, web site 492 may be a company web site which can be accessed by all users. GUI 494 is coupled to web site 492 to provide the user with a convenient way to view the data.

In one embodiment, the user may be provided with an option of adding new features to personal data capture device 400 over the wide area network. For example, the user may be notified of availability of a new or improved version for personal data capture device 400. The user may then be allowed to download the new or improved version directly over the Internet.

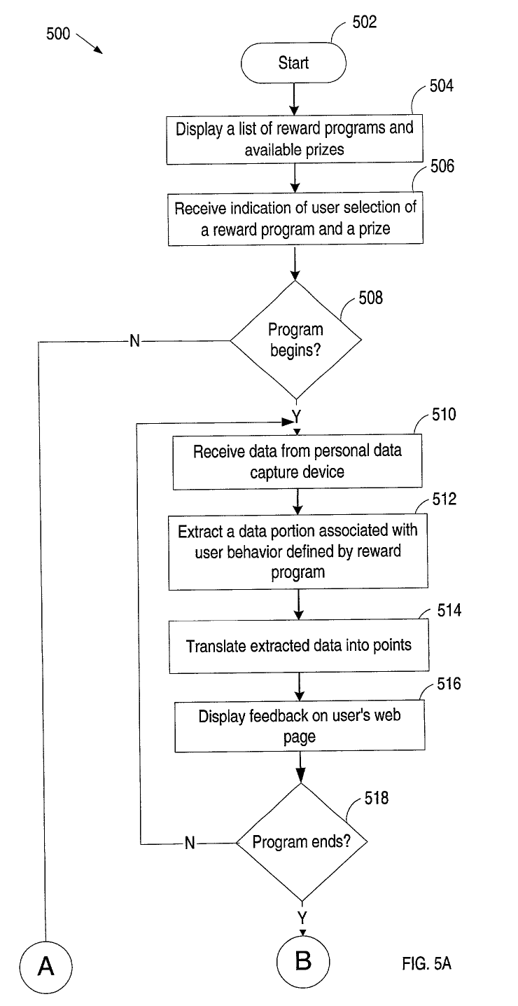

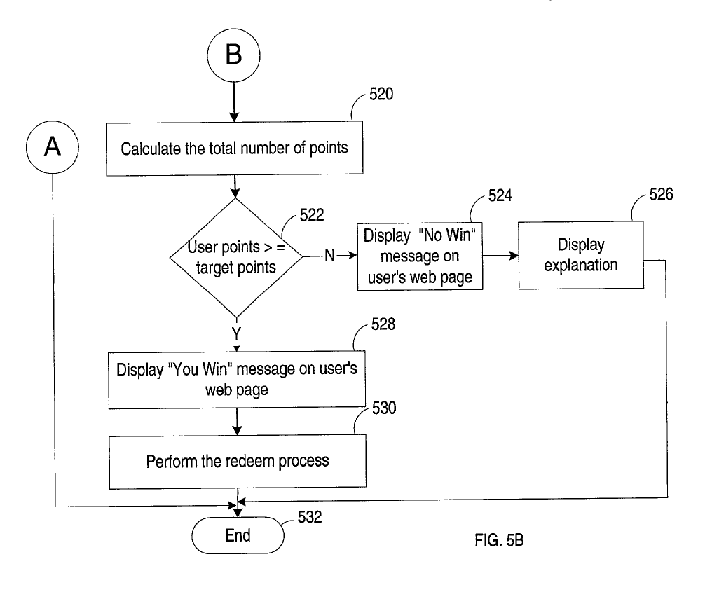

FIG. 5 is a flow diagram of a method 500 for monitoring user behavior beneficial to health, according to one embodiment of the present invention. Method 500 begins with displaying a list of available reward programs and prizes for user selection (processing block 504). Each reward program identifies a particular health-related activity, a performance target, and a time period during which this activity will be monitored. In one embodiment, the performance target is represented as the amount of points that the user must accumulate before the reward program ends. The points correspond to certain parameters of the activity (e.g., if the activity being monitored is walking, 1 point may be equal to 100 steps). In one embodiment, the program specifies the first day of the program and the last day of the program. In one embodiment, offered prizes are selected based on demographic reports.

When the reward program begins as determined at decision box 508, the data associated with various activities of the user is received from a personal data capture device (processing block 510). That is, this data is captured in the personal data capture device and periodically downloaded to a network server or a client computer. Next, a data portion that corresponds to the activity defined by the reward program is extracted (processing block 512) and translated into points (processing block 514). At processing block 516, feedback of behavior information is presented to the user. In one embodiment, the feedback is displayed on the user's web site.

At decision box 518, a determination is made as to whether the reward program has ended. If the determination is negative, method 500 returns to processing block 510. Otherwise, if the determination is positive, i.e., the reward program has ended, then the total number of points earned by the user is calculated (processing block 520) and compared with the points target.

If the total number of points earned by the user is below the target as determined at decision box 522, the message indicating that the user did not win the award is displayed (processing block 524), and an explanation is provided to specify why the user did not win (processing block 526). Alternatively, if the user has met the target, the message indicating that the user has won the award is displayed (processing block 528), and the redeem process is performed (processing block 530).

Several variations in the implementation of the method and system for rewarding behavior beneficial to health have been described. The specific arrangements and methods described here are illustrative of the principles of this invention. Numerous modifications in form and detail may be made by those skilled in the art without departing from the true spirit and scope of the invention. Although this invention has been shown in relation to a particular embodiment, it should not be considered so limited. Rather it is limited only by the appended claims.

What is claimed is:

1. A method for rewarding user behavior, the method comprising:
enrolling a user into a reward program, the reward program encouraging user behavior beneficial to health;
collecting data associated with the user behavior beneficial to health; and
evaluating the collected data to determine whether the collected data satisfies a performance target defined by the reward program.

2. The method of claim 1 further comprising dispensing an award to the user if the collected data satisfies the performance target.

3. The method of claim 1 wherein collecting data further comprises receiving data downloaded from a personal data capture device.

4. The method of claim 1 wherein the user behavior beneficial to health pertains to any one of a fitness activity, a medical treatment, and dietary habits.

5. The method of claim 1 wherein the reward program defines a start date and an end date for the user behavior beneficial to health.

6. The method of claim 5 wherein the performance target identifies the amount of points that the user must accumulate by engaging in the behavior beneficial to health between the start date and the end date.

7. The method of claim 5 further comprising providing constant feedback of behavior information to the user.

8. The method of claim 1 wherein an initiator of the reward program is a third party benefiting from the user behavior beneficial to health.

9. The method of claim 1 further comprising:
displaying a plurality of reward programs, each of the plurality of reward programs rewarding user engagement in a particular health-related activity;
receiving an indication of a user selection of one of the plurality of reward programs; and
displaying a list of awards available for the selected reward program.

10. The method of claim 1 wherein a group of users is enrolled in the reward program and wherein the method of claim 1 further comprises utilizing the reward program to control health-related activities of the group of users.

11. The method of claim 1 further comprising determining a list of awards that may be of interest to potential participants of the reward program based on demographic reports.

12. A system for rewarding user behavior, the system comprising:
a registration module to enroll a user into a reward program, the reward program encouraging user behavior beneficial to health; and
a point counter to collect data associated with the user behavior beneficial to health and to evaluate the collected data to determine whether the collected data satisfies a performance target defined by the reward program.

13. The system of claim 12 further comprising a redeem process to dispense an award to the user if the collected data satisfies the performance target.

14. The system of claim 12 wherein the point counter is to extract a data portion associated with the user behavior beneficial to health from data captured by a personal data capture device.

15. The system of claim 12 wherein the user behavior beneficial to health pertains to any one of a fitness activity, a medical treatment, and dietary habits.

16. The system of claim 12 wherein the reward program defines a start date and an end date for the user behavior beneficial to health.

17. The system of claim 16 wherein the performance target identifies the amount of points that the user must accumulate by engaging in the behavior beneficial to health between the start date and the end date.

18. The system of claim 16 further comprising a user interface to provide constant feedback of behavior information to the user.

19. The system of claim 12 wherein an initiator of the reward program is a third party benefiting from the user behavior beneficial to health.

20. The system of claim 12 further comprising:
a user interface to display a plurality of reward programs and a list of awards available for each of the plurality of reward programs, each of the plurality of reward programs rewarding user engagement in a particular health-related activity.

21. The system of claim 12 wherein a group of users is enrolled in the reward program and the reward program is use to control health-related activities of the group of users.

22. The system of claim 12 further comprising an analyzer to determine a list of awards that may be of interest to potential participants of the reward program based on demographic reports.

23. A computer readable medium that provides instructions, which when executed on a processor, cause said processor to perform operations comprising:
enrolling a user into a reward program, the reward program encouraging user behavior beneficial to health;
collecting data associated with the user behavior beneficial to health; and
evaluating the collected data to determine whether the collected data satisfies a performance target defined by the reward program.
